(19) United States
(12) Patent Application Publication
(10) Pub. No.: US 2023/0089721 A1
(43) Pub. Date: Mar. 23, 2023

(54) DIFFERENCE BASED MULTIPLE DEVICE CONFIGURATION RENDERING AND EDITING

(71) Applicant: HEWLETT PACKARD ENTERPRISE DEVELOPMENT LP, Houston, TX (US)

(72) Inventor: GURRAJ ATWAL, Roseville, CA (US)

(21) Appl. No.: 17/482,127

(22) Filed: Sep. 22, 2021

(51) Int. Cl. H04L 12/24

(52) U.S. Cl. CPC H04L 41/0813; H04L 41/085; H04L 41/0806

(57) ABSTRACT

Example implementations relate to difference based configuration editing and rendering. A multi-editor can facilitate the implementation of a change to multiple configurations for multiple devices. Based on the change, the multi-editor can determine sets of operations for the multiple devices. After the sets of operations are applied to the multiple devices, comparisons can be made based on the multiple configurations before the change is implemented and after the change is implemented. Based on the comparisons, differences can be determined for the multiple configurations. Based on the differences, the multi-editor can render the multiple configurations with improved processing efficiency and rendering performance. Furthermore, the multi-editor can determine sets of counter operations based on the differences for implementing an undo command.

### BACKGROUND

Advances in computer technologies have led to increasing integration of computer technologies in various industries. For example, many entities across various industries rely on computer networks for the storage, communication, and delivery of various products or services. These entities generally have a wide variety of needs and serve a wide variety of demands. As such, computer networks can take on a wide range of topologies and involve various types of devices to accommodate the wide variety of needs and demands. Furthermore, as computer technologies used across various industries advance, computer networks likewise grow increasingly complicated and involve increasingly greater numbers of devices with increasingly varied capabilities. Accordingly, as the wide variety of needs and demands involved in various industries promote advances in computer technologies, these needs and demands likewise promote advances in computer networking technologies. In this way, improvements in computer networking technologies can also provide improvements in other computer technologies.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example network configuration that may be implemented for an organization, such as a business, educational institution, governmental entity, healthcare facility, or other organization.

FIG. 2 illustrates an example computing component associated with difference (“diff”) based configuration editing and rendering.

FIG. 3A-3B illustrate example flows associated with difference based configuration editing and rendering.

FIG. 4 illustrates an example interface associated with difference based configuration editing and rendering.

FIG. 5 is an example computing component that may be used to implement various features of embodiments described in the present disclosure.

The figures are not exhaustive and do not limit the present disclosure to the precise form disclosed.

### DETAILED DESCRIPTION

As computer networks grow increasingly complex and involve increasingly greater numbers of devices with increasingly varied capabilities, computer networking technologies continue to face technological challenges. In general, computer networks include a wide variety of network devices with varying capabilities, and these network devices are configured for a variety of different purposes. For example, a network configuration for a business, or other organization, may include hundreds of network devices within a network. These hundreds of network devices may include various client devices of varying capabilities. Additionally, these hundreds of network devices may include, for example, various switches, routers, bridges, and other network devices to facilitate network traffic between the client devices. Like the client devices, these switches, routers, bridges, and other network devices may be of varying capabilities. In order for the network configuration to operate effectively, the network devices should be appropriately configured to communicate with the network. As the network devices have different capabilities, the network devices also have different configurations in order to effectively communicate with the network. Thus, as illustrated in this example, a network configuration may include numerous network devices with varying capabilities, and these network devices are configured differently in order to effectively communicate with the network.

Managing complex network configurations, such as those like the above described example network configuration, poses technological challenges. For example, a network administrator may wish to implement a new rule for a group of network devices. In order to implement the new rule, the network administrator changes the configurations of the network devices for which the new rule is to be implemented. As the network devices may have different capabilities and have different configurations, the changes to implement the new rule for the network devices may vary from one network device to another. Thus, in complex network configurations, implementing changes, such as implementing a new rule, poses technological challenges in that implementing the changes varies depending on the network device. These technological challenges are exacerbated as network configurations grow increasingly larger and complex. Furthermore, in some cases, a network administrator may wish to undo a new rule, or redo an undone rule. In these cases, the network administrator may undo an implemented rule by reloading old configurations for network devices for which the rule was implemented. However, reloading old configurations is computationally inefficient and requires substantial data storage to store old configurations, and these technological challenges are exacerbated in cases involving large numbers of devices. Thus, there is a need for technological solutions to address these and other technological challenges.

Accordingly, disclosed are systems and methods for difference (“diff”) based configuration editing and rendering. In various embodiments, a multi-editor can facilitate the implementation of a change to multiple configurations for multiple devices. The multi-editor can provide a user interface through which a user, such as a network administrator, can provide the change to be implemented. The multi-editor can determine sets of operations based on the change. A set of operations can make line by line changes to a configuration to implement the change on the configuration. The sets of operations can be applied to the multiple configurations for the multiple devices to implement the change on the multiple configurations. Comparisons can be made based on the multiple configurations before the change is implemented and after the change is implemented. Based on the comparisons, differences can be determined for the multiple configurations. The multi-editor can render the multiple configurations in the user interface based on the differences. By rendering the multiple configurations based on the differences instead of, for example, rendering new configurations in whole, the multi-editor can improve processing efficiency and rendering performance. In various embodiments, the multi-editor can determine sets of counter operations based on sets of operations to implement a change to multiple configurations for multiple devices. A set of counter operations can make line by line changes to a configuration to undo a change implemented by a set of operations corresponding to the set of counter operations. In response to an undo request from a user, the multi-editor can cause the sets of counter operations to be applied to the multiple configurations for the multiple devices. This can cause the change to be undone. In response to a redo request from the user, the multi-editor can cause the sets of operations corresponding to the sets of counter operations to be applied to the multiple configurations for the multiple devices. This can cause the change to be redone or reapplied. By implementing changes to configurations for devices based on operations and counter operations, redo and undo functions can be achieved without storing and reloading old configurations, providing improvements in processing efficiency and storage efficiency.

As an example of the above described systems and methods, a multi-editor can provide a user interface through which a network administrator can provide changes to be implemented in a network. For example, the network administrator can provide changes to implement a new virtual local area network (VLAN) in the network. Based on the changes, the multi-editor can determine sets of operations to implement the new VLAN. For example, the sets of operations can include instructions to route traffic from certain network devices through certain routers in accordance with the new VLAN. The sets of operations can vary from network device to network device depending on, for example, the capabilities or current configurations of the network devices. The multi-editor can cause the sets of operations to be applied to the network devices in the network. A comparison can be made between the configurations of the network devices before the sets of operations were applied and after the sets of operations were applied. Based on the comparison, differences of the configurations of the network devices can be determined. The multi-editor can render the configurations of the network devices, with the changes applied, on the user interface based on the differences. For example, the multi-editor can render the portions of the configurations that were changed by the sets of operations while maintaining the unchanged portions of the configurations instead of rendering the entire configurations. In this example, the network administrator can decide to undo the changes to implement the new VLAN. The multi-editor can determine sets of counter operations to undo the changes to implement the new VLAN. The sets of counter operations can include, for example, instructions to delete lines corresponding to the instructions to route traffic from certain network devices through certain routers in accordance with the new VLAN. The sets of counter operations can vary from network device to network device depending on, for example, the capabilities or current configurations of the network devices. The multi-editor can cause the sets of counter operations to be applied to the network devices in the network instead of, for example, causing old configurations for the network devices in the network to be reloaded. In this example, the network administrator can decide to redo the changes to implement the new VLAN. The multi-editor can cause the sets of operations previously determined to implement the new VLAN to be applied to the network devices in the network. As illustrated in this example, the multi-editor provides difference based rendering and editing that provides improved processing efficiency and storage efficiency. Further details of the disclosed systems and methods for difference based rendering and editing are described herein.

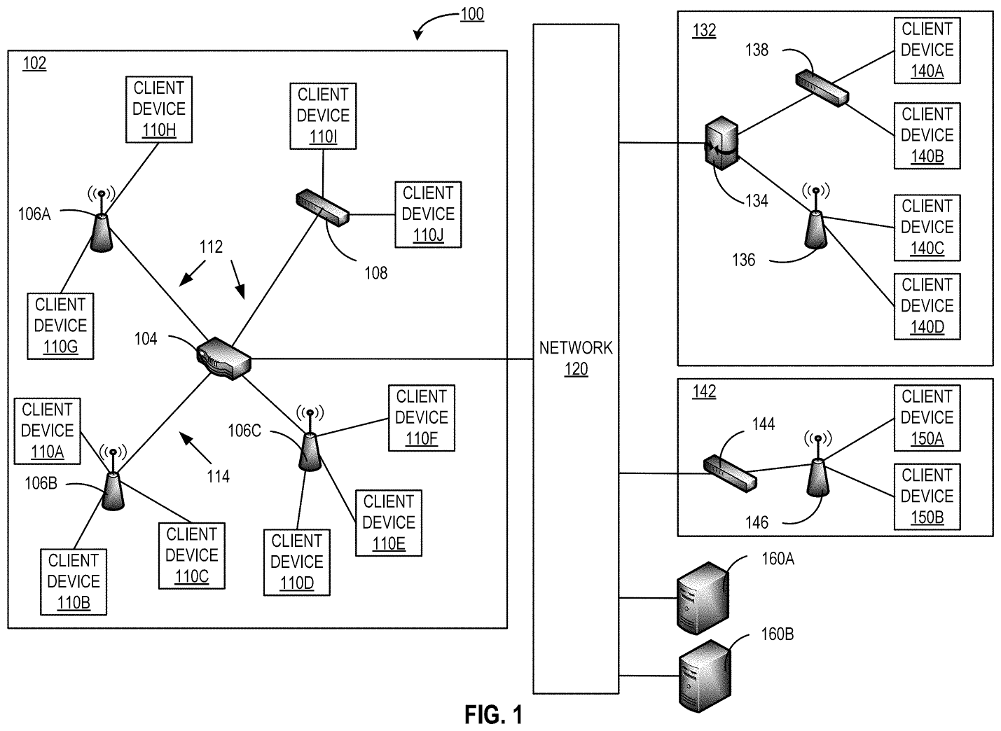

Before describing embodiments of the disclosed systems and methods in detail, it may be useful to describe an example network configuration with which these systems and methods might be implemented in various applications. FIG. 1 illustrates one example of a network configuration 100 that may be implemented for an organization, such as a business, educational institution, governmental entity, healthcare facility or other organization. This diagram illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which can be, for example, an office network, home network or other network installation. The primary site 102 network may be a private network, such as a network that may include security and access controls to restrict access to authorized users of the private network. Authorized users may include, for example, employees of a company at primary site 102, residents of a house, customers at a business, and so on. In some cases, devices associated with the private network may have different configurations to implement the security and access controls associated with the private network in accordance with the different capabilities that the devices may have.

In the illustrated example, the primary site 102 includes a controller 104 in communication with the network 120. The controller 104 may provide communication with the network 120 for the primary site 102. The controller 104 may be in communication with one or more switches 108 and/or wireless Access Points (APs) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120. Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless. Wireless APs 106a-c are included as another example of a point of access to the network established in primary site 102 for client devices 110a-h. In the illustrated example, APs 106a-c can be managed and configured by the controller 104. APs 106a-c communicate with the controller 104 and the network over connections 112, which may be either wired or wireless interfaces. In some cases, APs 106a-c may, for example, have different hardware and have different capabilities. While APs 106a-c may provide the same functionalities in the primary site 102, APs 106a-c may provide those functionalities in different ways or based on different sets of instructions. Similarly, client devices 110a-j may also have different capabilities and access the network 120 based on different sets of instructions.

The network configuration 100 may include one or more remote sites 132. A remote site 132 may be in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be, for example, a satellite office, another floor, or suite in a building, and so on. The remote site 132 may include a gateway device 134 for communicating with the network 120. The remote site 132 may also include a switch 138 and/or AP 136 in communication with the gateway device 134 over either wired or wireless connections. The switch 138 and AP 136 provide connectivity to the network for various client devices 140a-d.

In some cases, the remote site 132 may be in direct communication with primary site 102, such that client devices 140a-d at the remote site 132 access the network resources at the primary site 102 as if these clients' devices 140a-d were located at the primary site 102. In such embodiments, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102. As a logically separate site, the remote site 132 may be subject to different rules than the primary site 102. Accordingly, the gateway device 134, the switch 138, the AP 136 and the client devices 140a-d may have different configurations than, for example, the APs 106a-c and the client devices 110a-j of the primary site 102. Furthermore, within the remote site 132, the gateway device 134, the switch 138, the AP 136 and the client devices 140a-d may have different configurations in accordance with their different capabilities.

The network configuration 100 may include one or more smaller remote sites 142, comprising a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the primary site 102, such that the client devices 150a-b at remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102. As a logically separate site, the remote site 142 may be subject to different rules than the remote site 132 and the primary site 102. Accordingly, the gateway device 144, the wireless AP 146 and the client devices 150a-b may have different configurations than, for example, the APs 106a-c and the client devices 110a-j of the primary site 102 and, for example, the gateway device 134, the switch 138, the AP 136 and the client devices 140a-d of the remote site 132. Furthermore, within the remote site 142, gateway device 144, the wireless AP 146 and the client devices 150a-b may have different configurations in accordance with their different capabilities.

The network configuration 100 may include various content servers 160a-b. Content servers 160a-b may include various providers of multimedia downloadable and/or streaming content, including audio, video, graphical, and/or text content, or any combination thereof. Examples of content servers 160a-b include, for example, web servers, streaming radio and video providers, and cable and satellite television providers. The client devices 110a j, 140a-d, 150a-b may request and access the multimedia content provided by the content servers 160a-b.

Although ten client devices 110a-j are illustrated at primary site 102 in the example of FIG. 1, in various applications, a network may include dramatically larger quantities of client devices. For example, various wireless networks may include hundreds, thousands, or even tens of thousands of client devices communicating with their respective APs, potentially at the same time. Thus, as illustrated in the example of FIG. 1, the various devices of a network configuration can have different configurations in accordance with the different sites to which they belong, the different hardware and capabilities they have, and various other factors. Thus, managing the network configuration and implementing changes to the network configuration can be technologically challenging. As further described herein, the disclosed systems and methods for difference based rendering and editing provide technological solutions to these technological challenges.

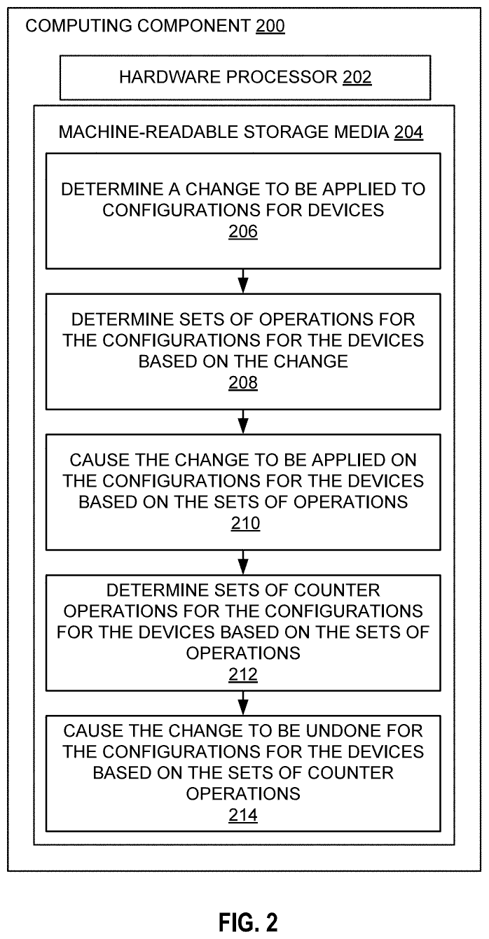

FIG. 2 illustrates an example computing component that may be used to implement difference (“diff”) based rendering and editing in accordance with various embodiments. Referring now to FIG. 2, computing component 200 may be, for example, a server computer, a controller, or any other similar computing component capable of processing data. In the example implementation of FIG. 2, the computing component 200 includes a hardware processor 202 and machine-readable storage medium 204.

Hardware processor 202 may be one or more central processing units (CPUs), semiconductor-based microprocessors, and/or other hardware devices suitable for retrieval and execution of instructions stored in machine-readable storage medium 204. Hardware processor 202 may fetch, decode, and execute instructions, such as instructions 206-214, to control processes or operations for difference based rendering and editing. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 204 may be a non-transitory storage medium, where the term “non-transitory” does not encompass transitory propagating signals. As described in detail below, machine-readable storage medium 204 may be encoded with executable instructions, for example, instructions 206-214 for difference based rendering and editing.

In various embodiments, configurations for devices can be sorted in accordance with a common scheme. Based on the common scheme, a range where a configuration property can be located can be determined. For example, a configuration property, in accordance with a common scheme, may be generally sorted near the top of a configuration. Based on the common scheme, a range, such as a range of lines in the configuration, can be determined for locating the configuration property. In traversing the configuration, if the range of lines is traversed without locating the configuration property, it can be determined that the configuration property has not been set. Sorted configurations can provide improvements in processing efficiency in calculating differences and rendering configurations based on differences, as further described herein.

Hardware processor 202 may execute instruction 206 to determine a change to be applied to configurations for devices. In various embodiments, a change to be applied to configurations for devices can be provided through a user interface of a multi-editor. The multi-editor can render configurations for devices and provide the configurations in the user interfaces. For example, a configuration can be rendered and provided as lines of configuration properties. In cases where the configurations are sorted, the configurations can be provided as sorted lines of configuration properties. Providing a sorted configuration may facilitate navigation of the configuration as the user can determine, based on the sorting, where a configuration property can be located. In various embodiments, a change to be applied to configurations for devices can be provided by adding lines or removing lines from the rendered configuration. The entered lines can correspond with new properties to be implemented or other commands to be applied to the configurations. Removing lines can correspond with properties to be removed from the configuration or removal of previously applied commands from the configurations. In some cases, changes to be applied to configurations can be provided through other inputs. For example, an undo command can be provided through a keyboard shortcut or a button on the user interface. In some cases, a redo command can be provided through a different keyboard shortcut or a different button on the user interface. Many variations are possible.

Hardware processor 202 may execute instruction 208 to determine sets of operations for the configurations for the devices based on the change. A set of operations for a configuration for a device can include instructions for implementing a change to the configuration. For example, a set of operations to add a configuration property can include a first instruction to add a new line to a configuration for a device, a second instruction to enter the configuration property on the new line, and a third instruction to change a value for the configuration property on the new line. In some cases, implementing a change to a configuration for a device can involve additional changes resulting from the change to the configuration. A set of operations for a configuration for a device can include instructions to implement the change and the additional changes resulting from the change. For example, a change to a configuration of a device to add the device to a VLAN may involve additional changes in how the device identifies itself, what services the device enables, or additional changes that may be inherited from the VLAN. In this example, a set of operations to implement the change to the configuration for the device can include operations to implement the additional changes related to the change. In some cases, a change to be implemented for multiple configurations for multiple devices may involve no changes to one or more of the multiple configurations. For example, some of the multiple configurations may inherit the change to be implemented from their device grouping or may have the configuration property associated with the change set to the desired value by default. In these cases, sets of operations for the multiple configurations for the multiple devices can include sets of operations to implement the change for the configurations where changes are to be implemented and sets of operations that make no changes for the configurations where no changes are to be implemented. Many variations are possible.

Hardware processor 202 may execute instruction 210 to cause the change to be applied on the configurations for the devices based on the sets of operations. In various embodiments, the sets of operations are provided to the devices to which a change is to be implemented. In some cases, the sets of operations are used to implement the change through a backend system in communication with the devices to which the changes are to be implemented. With the changes implemented, a difference for a device can be determined based on a comparison of the configuration of the device before the change was implemented with the configuration of the device after the change was implemented. In some cases, the difference can be determined by iterating through the configuration of the device before the change was implemented and iterating through the configuration of the device after the change was implemented. In these cases, the configuration of the device before the change was implemented and the configuration of the device after the change was implemented can be compared line by line to determine what lines were added, removed, or modified as a result of the change to the configuration. In some cases where the configuration is sorted, the difference may be determined without full iterating through the configuration of the device. Based on the change implemented, a range where lines were added, removed, or modified as a result of the change can be determined. By iterating through the range, the difference can be determined for the change. For example, a change can be implemented to a configuration for a device. To determine a difference for the device, a first configuration of the device before the change was implemented can be compared with a second configuration of the device after the change was implemented. A two-pointer approach can be used to compare the first configuration with the second configuration line by line. For each line where the first configuration matches the second configuration, the pointers for both configurations are incremented. When a difference is identified the pointer associated with the difference is incremented. In this way, the lines where the difference between the first configuration and the second configuration are located can be determined. The difference for the device can be based on the content of the lines determined in this way.

In various embodiments, differences based on changes to configurations for devices can serve as the basis for rendering the changed configurations. For example, a change can be implemented to a configuration, and a changed configuration can be provided to a multi-editor. The multi-editor can determine a difference based on the configuration before the change was implemented and the changed configuration. The multi-editor can render the difference and apply the difference to a previously rendered configuration, which may be rendered based on the configuration before the change was implemented or based on a previously rendered difference. In some cases, a difference determined for devices to which a change was implemented can be provided to a multi-editor. Based on the difference, the multi-editor can render the difference and apply the difference to a previously rendered configuration for the devices. In these ways, the multi-editor can improve processing efficiency compared to, for example, receiving full configurations of devices and rendering the full configurations.

Hardware processor 202 may execute instruction 212 to determine sets of counter operations for the configurations for the devices based on the sets of operations. In various embodiments, sets of counter operations can be determined to reverse corresponding sets of operations that were determined to implement a change for configurations for devices. For example, a set of operations to add a configuration property can include a first instruction to add a new line to a configuration for a device, a second instruction to enter the configuration property on the new line, and a third instruction to change a value for the configuration property on the new line. A set of counter operations corresponding to the set of operations can include an instruction to delete the new line. As another example, a set of operations to change a configuration property can include an instruction to change an original value for the configuration property to a new value. A set of counter operations corresponding to the set of operations can include an instruction to change the value of the configuration property to the original value. In some cases, the set of counter operations can be determined based on a difference. For example, a change implemented on a configuration of a device can result in the addition of three new lines to the configuration of the device. A difference based on a comparison of the configuration of the device before the change is implemented with the configuration of the device after the change is implemented can determine that the three new lines were added. Based on the difference, a set of counter operations can include instructions to delete the three new lines. Many variations are possible.

Hardware processor 202 may execute instruction 214 to cause the change to be undone for the configurations for the devices based on the sets of counter operations. In various embodiments, the sets of counter operations are provided to the devices for which a change is to be undone. In some cases, the sets of counter operations are used to undo the change through a backend system in communication with the devices for which the change is to be undone. In some cases, a difference for the devices can be determined based on a comparison of the configurations of the devices before the change was undone with the configurations of the devices after the change was undone. In some cases, the previous configuration of the devices can be rendered again to provide the current configuration of the devices. For example, a multi-editor can provide the render of a previous configuration in response to an undo command or the multi-editor can render a portion of the configuration based on a difference determined from changes made to the configuration based on the undo command. In order to facilitate a redo command, a multi-editor can provide sets of operations that were previously provided prior to an undo command. Thus, the multi-editor can facilitate the undo and redo of changes to configurations in devices without relying on reloading of old configurations by the devices, which provides improvements in processing efficiency and storage efficiency.

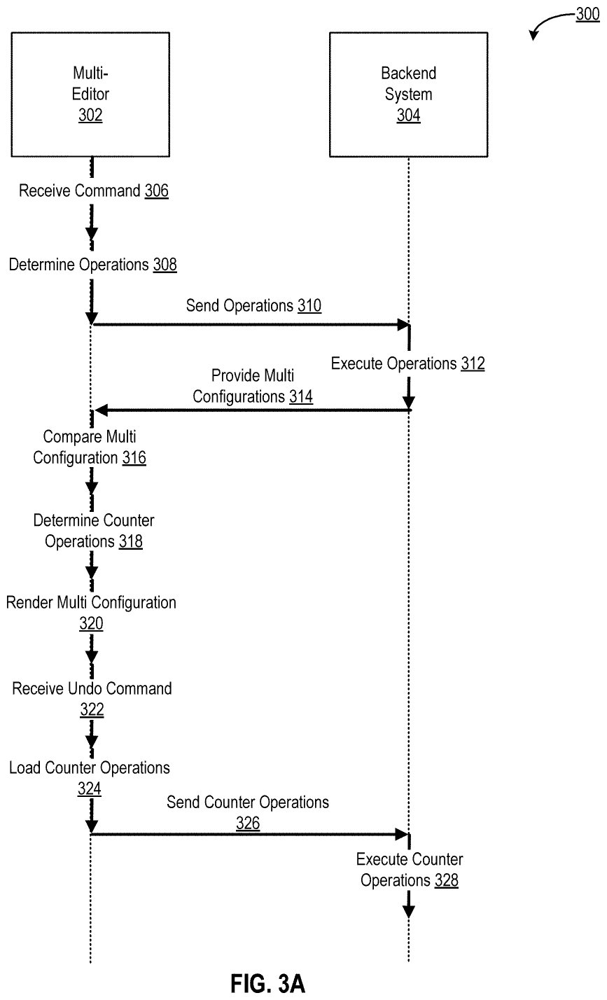

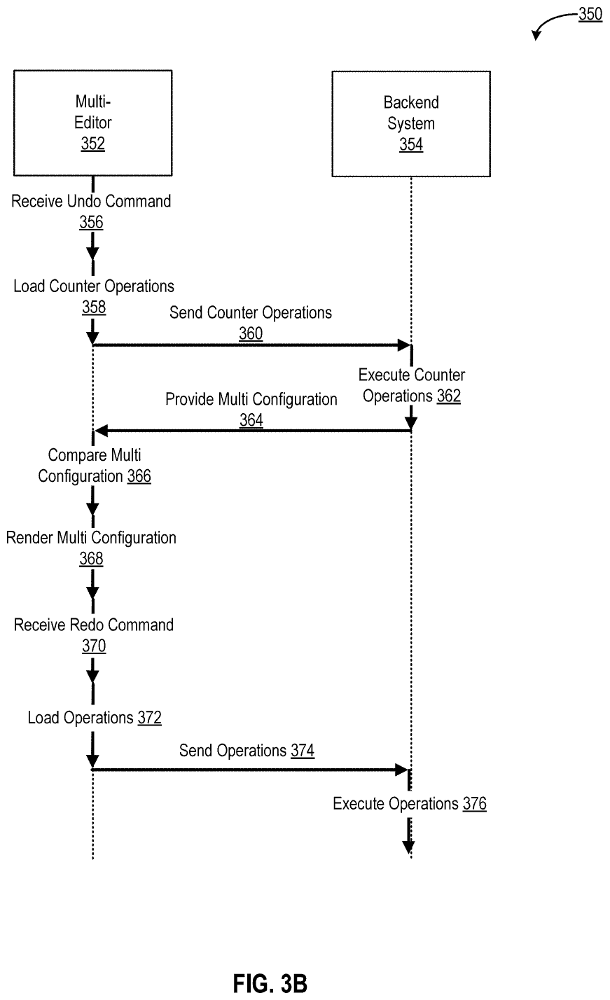

FIGS. 3A-B illustrate example flows associated with difference (“diff”) based configuration editing and rendering in accordance with various embodiments. The example flows can be associated with one or more functionalities performed by, for example, the example computing component 200 of FIG. 2. It should be understood that there can be additional, fewer, or alternative steps performed in similar or alternative orders, or in parallel, based on the various features and embodiments discussed herein unless otherwise stated.

FIG. 3A illustrates an example flow 300 associated with provision of operations and counter operations based on a command in accordance with various embodiments. As illustrated in FIG. 3A, the example flow 300 involves a multi-editor 302 and a backend system 304. At step 306, the multi-editor 302 receives a command. The command can involve, for example, a change to be applied to a multi configuration, or multiple configurations of devices in a network. The command can be received, for example, through a user interface provided by the multi-editor 302. At step 308, the multi-editor 302 determines operations. The operations can be determined based on the command and include instructions to implement the command. At step 310, the multi-editor 302 sends the operations to the backend system 304. At step 312, the backend system 304 executes the operations. Executing the operations can involve, for example, updating internal representations of the configurations in the backend system 304. The backend system 304 can apply the internal representations of the multiple configurations to the devices, for example, in response to a save command. At step 314, the backend system 304 can provide a multi configuration to the multi-editor 302. At step 316, the multi-editor 302 can compare the multi configuration. The multi-editor 302 can compare, for example, the multiple configurations of the devices before executing the operations with the multiple configurations of the devices after executing the operations. A comparison (e.g., diff) can be generated based on the comparison. In some cases, the difference can be generated by a backend system, such as the backend system 304 and be provided to a multi-editor, such as the multi-editor 302. In these cases, the multi-editor does not need to generate the difference as it is provided by the backend system. At step 318, the multi-editor 302 determines counter operations. The counter operations can include instructions to reverse the operations determined by the multi-editor 302 at step 308. At step 320, the multi-editor 302 renders the multi configuration. Rendering the multi configuration can be based on the difference from step 316 and provides the changes to the configuration resulting from the execution of the operations determined by the multi-editor 302. The multi-editor 302 can update its render of the configurations of the devices in the network accordingly. At step 322, an undo command can be received by the multi-editor 302. At step 324, the multi-editor 302 can load counter operations. The counter operations can be, for example, determined at step 318. At step 326, the multi-editor 302 sends the counter operations to the backend system 304. At step 328, the backend system 304 executes the counter operations. Executing the counter operations undoes the changes resulting from executing the operations at step 312.

FIG. 3B illustrates an example flow 350 associated with provision of operations and counter operations based on a command in accordance with various embodiments. As illustrated in FIG. 3B, the example flow 350 involves a multi-editor 352 and a backend system 354. The multi-editor 352 and the backend system 354 can, in some cases, be the multi-editor 302 and the backend system 304 of FIG. 3A. At step 356, the multi-editor 352 can receive an undo command. The undo command can, for example, seek to undo operations executed based on a previous command. At step 358, the multi-editor 352 can load counter operations 358. The counter operations can have been previously determined and can reverse the operations associated with the previous command. At step 360, the multi-editor 352 can send the counter operations to the backend system 354. At step 362, the backend system 354 can execute the counter operations. Executing the counter operations can involve, for example, updating internal representations of the configurations in the backend system 354, effectively undoing previously executed operations associated with the previous command. The backend system 354 can apply the internal representations of the multiple configurations to the devices, for example, in response to a save command. At step 364, the backend system 354 can provide a multi configuration to the multi-editor 352. At step 366, the multi-editor can compare the multi configuration. The multi-editor 352 can compare, for example, the multiple configurations of the devices before executing the counter operations with the multiple configurations of the devices after executing the counter operations. A comparison (e.g., diff) can be generated based on the comparison. In some cases, the difference can be generated by a backend system, such as the backend system 354 and be provided to a multi-editor, such as the multi-editor 352. In these cases, the multi-editor does not need to generate the difference as it is provided by the backend system. At step 368, the multi-editor 352 renders the multi configuration. Rendering the multi configuration can be based on the difference from step 366 and provides the changes to the configuration resulting from the execution of the counter operations determined by the multi-editor 352. The multi-editor 352 can update its render of the configurations of the devices in the network accordingly. At step 370, a redo command can be received by the multi-editor 352. The operations to implement the redo command can be the same operations previously determined based on the previous command before the undo command. At step 372, the multi-editor 352 can load the operations to implement the redo command. At step 374, the multi-editor 352 sends the operations to the backend system 354. At step 376, the backend system 354 executes the operations. Executing the operations redoes the previous command before the undo command. As illustrated in this example, undo commands and redo commands can be efficiently performed without saving and reloading configurations of the devices in the network.

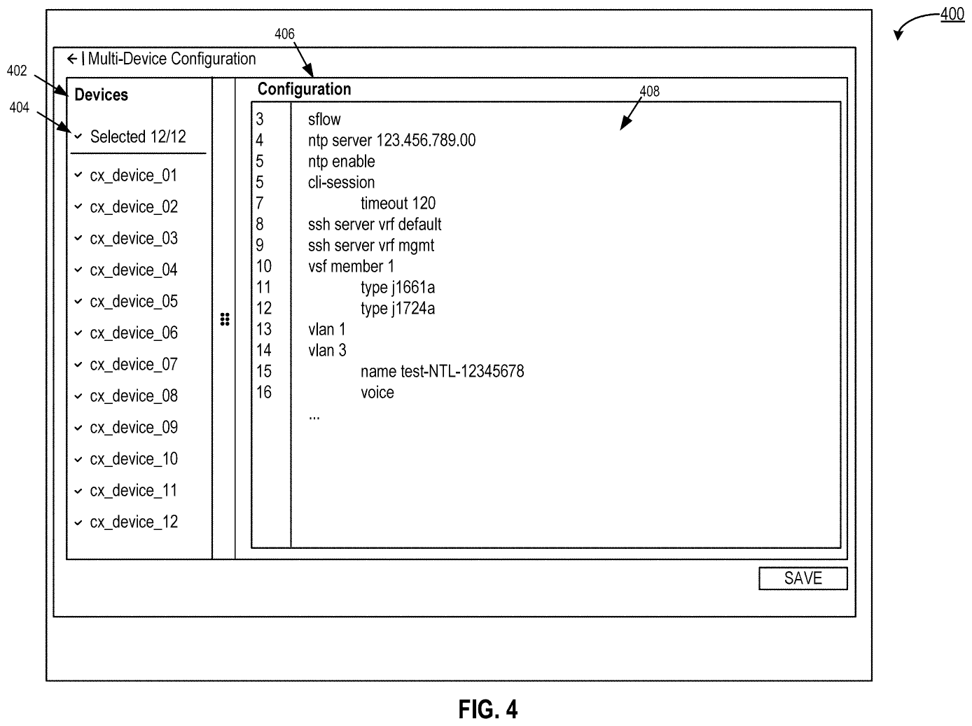

FIG. 4 illustrates an example interface 400 associated with difference (“diff”) based configuration editing and rendering in accordance with various embodiments. The example interface can be associated with one or more functionalities performed by, for example, the example computing component 200 of FIG. 2. It should be understood that there can be additional, fewer, or alternative steps performed in similar or alternative orders, or in parallel, based on the various features and embodiments discussed herein unless otherwise stated.

As illustrated in FIG. 4, the example interface 400 displays tools associated with a multi-editor. The example interface 400 includes a devices section 402. The devices section 402 lists devices associated with a network. As illustrated in FIG. 4, the devices section 402 includes a selected indicator 404 indicating that there are twelve devices associated with the network and that twelve of the devices are selected. In this way, the devices section 402 allows for multiple devices to be selected for configuration. The example interface 400 includes a configuration section 406. The configuration section 406 provides a render 408 of the configurations of the twelve selected devices. The render 408 includes configuration properties common to the twelve selected devices. In some cases, a render, such as the render 408, can also include lines that are not common, such as a line associated with one of the twelve selected devices or a line associated with five of the twelve selected devices. The configuration section 406 can allow for edits to be made to the configurations of the twelve selected devices. Based on the edits, changes can be made to the configurations of the twelve selected devices, for example, by determining a set of operations based on the changes and causing the set of operations to be applied to the twelve selected devices. Based on the changes made to the configurations of the twelve selected devices, a render of the changes can be applied to the render 408, for example, by determining a difference between the configurations of the twelve selected devices before and after the changes were made. In this way, the render 408 can be updated to reflect the current configurations of the twelve selected devices. Many variations are possible.

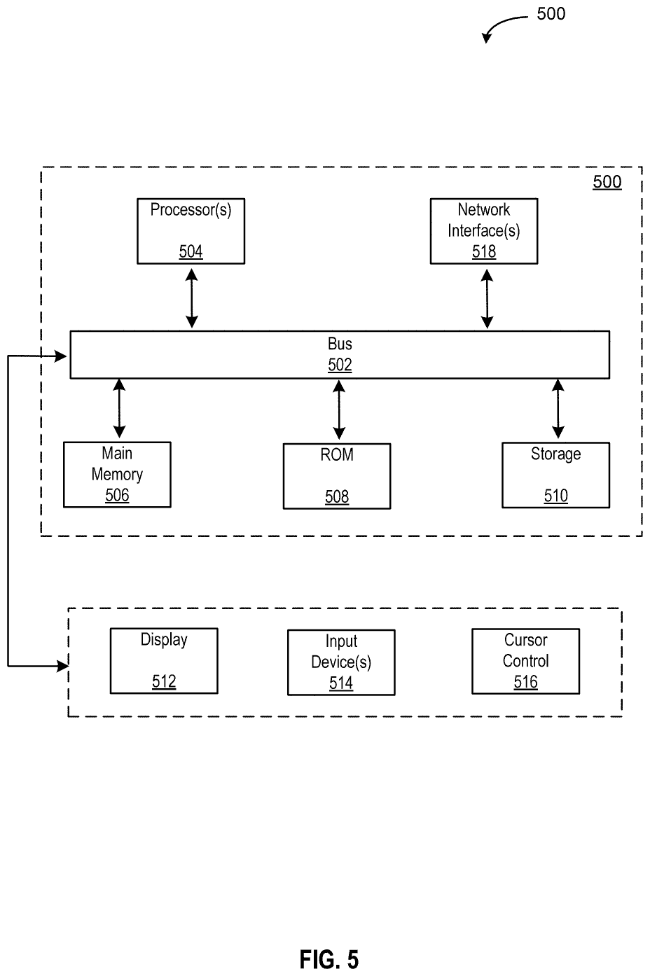

FIG. 5 illustrates a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A method comprising:
determining, by a configuration editor, a change to be applied to configurations for devices;
determining, by the configuration editor, sets of operations for the configurations for the devices based on the change;
causing, by the configuration editor, the change to be applied on the configurations for the devices based on the sets of operations;
determining, by the configuration editor, sets of counter operations for the configurations for the devices based on the sets of operations, wherein the sets of counter operations for the configurations for the devices are determined based on a difference between the configurations for the devices before the changes is applied and the configurations for the devices after the changed is applied, and wherein the sets of counter operations comprise instructions to delete lines corresponding to the sets of operations; and
causing, by the configuration editor, a portion of the change to be removed for the configurations for the devices based on the sets of counter operations.

2. The method of claim 1, further comprising:
determining, by the configuration editor, a render of the configurations for the devices based on the difference between the configurations for the devices before the changes is applied and the configurations for the devices after the changed is applied; and
providing, by the configuration editor, the render of the configurations for the devices.

3-4. (canceled)

5. The method of claim 1, further comprising:
providing, by the configuration editor, a user interface by which the change to be applied to the configurations for the devices is determined.

6. The method of claim 1, wherein the sets of operations include instructions for at least one of: adding, removing, or modifying a line in the configurations for the devices.

7. The method of claim 1, further comprising:
causing, by the configuration editor, the change to be redone for the configurations for the devices based on the sets of operations.

8. The method of claim 1, wherein the configurations for the devices include sorted lists of configuration properties.

9. A system, comprising:
a processor; and
a memory operatively connected to the processor, and including computer code that when executed, causes the system to:
determine a change to be applied to configurations for devices;
determine sets of operations for the configurations for the devices based on the change;
cause the change to be applied on the configurations for the devices based on the sets of operations;
determine sets of counter operations for the configurations for the devices based on the sets of operations, wherein the sets of counter operations for the configurations for the devices are determined further based on the difference between the configurations for the devices before the changes is applied and the configurations for the devices after the changed is applied, and wherein the sets of counter operations comprise instructions to delete lines corresponding to the sets of operations; and
cause a portion of the change to be removed for the configurations for the devices based on the sets of counter operations.

10. The system of claim 9, wherein the computer code further causes the system to:
determine a render of the configurations for the devices based on the difference between the configurations for the devices before the changes is applied and the configurations for the devices after the changed is applied; and
provide the render of the configurations for the devices.

11-12. (canceled)

13. The system of claim 9, wherein the computer code further causes the system to:
provide a user interface by which the change to be applied to the configurations for the devices is determined.

14. The system of claim 9, wherein the computer code further causes the system to:
cause the change to be redone for the configurations for the devices based on the sets of operations.

15. A non-transitory computer-readable storage medium including instructions that, when executed by at least one processor of a computing system, cause the computing system to:
determine a change to be applied to configurations for devices;
determine sets of operations for the configurations for the devices based on the change;
cause the change to be applied on the configurations for the devices based on the sets of operations;
determine sets of counter operations for the configurations for the devices based on the sets of operations, wherein the sets of counter operations for the configurations for the devices are determined further based on the difference between the configurations for the devices before the changes is applied and the configurations for the devices after the changed is applied, and wherein the sets of counter operations comprise instructions to delete lines corresponding to the sets of operations; and
cause a portion of the change to be removed for the configurations for the devices based on the sets of counter operations.

16. The non-transitory computer-readable storage medium of claim 15, wherein the instructions further cause the computing system to:
determine a render of the configurations for the devices based on the difference between the configurations for the devices before the changes is applied and the configurations for the devices after the changed is applied; and
provide the render of the configurations for the devices.

17-18. (canceled)

19. The non-transitory computer-readable storage medium of claim 15, wherein the instructions further cause the computing system to:
provide a user interface by which the change to be applied to the configurations for the devices is determined.

20. The non-transitory computer-readable storage medium of claim 15, wherein the instructions further cause the computing system to:
cause the change to be redone for the configurations for the devices based on the sets of operations.

21. The method of claim 1, wherein causing, by the configuration editor, the change to be applied on the configurations for the devices based on the sets of operations comprises changing a value of a configuration property of the configurations from an original value to a new value that does not match the original value.

22. The method of claim 21, wherein the sets of counter operations further comprise instructions to change the new value of the configuration property of the configurations to the original value.

23. The method of claim 22, further comprising comparing the configurations after the portion of the change is removed with the configurations prior to the portion of the change being removed.

24. The method of claim 1, wherein the change causes line by line configuration to reapply the change.

25. The method of claim 1, wherein the change causes creation of a new virtual local area network (VLAN) in a current network.

26. The method of claim 1, wherein the sets of counter operations further comprise instructions to sort lines in the configurations for devices prior to determining where a configuration property to be changed is located.
